(19) United States
(12) Patent Application Publication
(10) Pub. No.: US 2004/0120230 A1
(43) Pub. Date: Jun. 24, 2004

(54) Apparatus and method for adjusting optical pickup

(75) Inventors: Yasuhisa Miyata, Saitama-ken (JP); Masahiro Nakahashi, Saitama-ken (JP)

Correspondence Address: MCGINN & GIBB, PLLC, 8321 OLD COURTHOUSE ROAD, SUITE 200, VIENNA, VA, 22182-3817, US

(73) Assignees: Pioneer Corporation, Tokyo (JP); Pioneer FA Corporation, Tsurugashima-shi (JP)

(21) Appl. No.: 10/732,454

(22) Filed: Dec. 11, 2003

(30) Foreign Application Priority Data
Dec. 20, 2002 (JP) 2002-369238

(51) Int. Cl. G11B 7/095

(52) U.S. Cl. 369/44.29

(57) ABSTRACT

A light receiving unit 20A has a half mirror 20Aa and a photoreceptor device 20Af. A signal processing member 20B generates a focus error signal e from photoelectric conversion signals a, b, c and d which are outputted from the light receiving unit 20A, and further generates a focus error signal e1 from photoelectric conversion signals a1, b1, c1 and d1 which are outputted from a photoreceptor device 7 of an optical pickup P subject to adjustment. A control member 20C performs attitude control on an actuator 5A of an objective lens of the optical pickup P based on the focus error signal e, and creates data for adjusting the optical pickup P based on the focus error signal e1.

### BACKGROUND OF THE INVENTION

1. Field of the Invention

This invention relates to an apparatus and a method for adjusting the optical system of an optical pickup provided for reading information recorded in an optical disc and writing information into the optical disc.

The present application claims priority from Japanese Application No. 2002-369238, the disclosure of which is incorporated herein by reference.

2. Description of the Related Art

FIG. 1 is a perspective view schematically illustrating a typical structure of an optical pickup used in a DVD player or DVD recorder.

In FIG. 1, an optical pickup P is constituted of: a DVD (Digital Versatile Disc) laser diode LD1 and a CD (Compact Disc) laser diode LD2 for outputting beams at different wavelengths from each other; half mirrors 1 and 2 and a mirror 3 for guiding an output beam b1, emitted from the DVD laser diode LD1 or CD laser diode LD2, along a predetermined path; a collimator lens 4 for making the output beam b1 come in parallel light rays; an objective lens 5 undergoing attitude control by an actuator to irradiate a disc with the beam; a multi lens 6 for receiving a beam b2 reflected off the disc D and then passing through the objective lens 5, collimator lens 4, mirror 3 and half mirror 2; and a photoreceptor device 7, such as a photo-detector or an optical electronics IC, for receiving the reflected beam b2 focused by the multi lens 6, to read the information.

Prior to the process of mounting the optical pickup on a player or recorder in the manufacturing process, the optical pickup P undergoes: an attitude adjustment to the actuator actuating the objective lens 5 by use of a beam spot adjuster (an output-path optical-axis adjustment); a focus adjustment to the multi lens 6 and a positional adjustment to the photoreceptor device 7 by use of an optical-path adjuster (a receptor optical axis adjustment); and an optical-axis adjustment of the CD laser diode LD2 by use of the optical-path adjuster after completion of the focus adjustment of the multi lens 6 and the positional adjustment of the photoreceptor device 7.

FIG. 2 is a schematic block diagram illustrating a conventional optical path adjuster, and FIG. 3 is a diagram illustrating an adjusting method using the conventional optical path adjuster.

For the foregoing adjustments, the conventional optical path adjuster 10 uses an optical pickup P to actually irradiate a disc D with a beam. The optical path adjuster 10 includes a disc drive 10A for rotationally driving the disc D used in the adjustment process; a pickup control circuit 10B for executing the drive control of the disc drive 10A and an operation control for an actuator 5A of an objective lens 5 of the optical pickup P; a signal processing circuit 10C for processing a disc signal detected by an photoreceptor device 7 of the optical pickup P; a measurement hardware 10D for analyzing the disc signal undergoing the signal processing in the signal processing circuit 10C, and using a jitter meter or an oscilloscope for analyzing the focus and the optical axis position of the reflected beam b2 (see FIG. 1) entering the photoreceptor device 7; and a main controller (e.g. personal computer) 10E for making an assessment of the optical pickup adjustment on the basis of the result of analysis made by the measurement hardware 10D, and creating adjustment data.

The optical axis adjuster 10 adjusts the optical axis in the optical pickup P by following the procedure as illustrated in the flowchart in FIG. 4.

After the completion of attitude adjustment made to the actuator 5A by use of the beam spot adjuster (the output-path optical axis adjustment), the optical pickup P is placed in the checking position of the optical axis adjuster 10, and connected to a power supply circuit (not shown). Then the actuator 5A is connected to the pickup control circuit 10B, and the photoreceptor device 7 is connected to the signal processing circuit 10C.

At this point, the optical axis adjuster 10 starts rotating the disc D, and starts the DVD laser diode LD1 emitting light (step s1).

Upon the photoreceptor device 7 receiving a reflected beam b2 from the disc D and outputting a disc signal, the signal processing circuit 10C fetches the disc signal (step s2).

The signal processing circuit 10C performs the signal processing on the disc signal fetched from the photoreceptor device 7, and generates therefrom a drive control signal for the disc drive 10A and an attitude control signal for the actuator 5A (step s3). Then, based on the drive control signal and the attitude control signal, the pickup control circuit 10B performs the drive control on the disc drive 10A and enables the actuator SA to control the attitude of the objective lens 5 (step s4).

After the completion of the drive control for the disc drive 10A and the attitude control for the actuator 5A by the pickup control circuit 10B, the photoreceptor device 7 receives the reflected beam b2 and outputs a disc signal. Thereupon, the signal processing circuit 10C performs measurement signal processing on the disc signal (step s5).

Then, based on the disc signal undergoing the measurement signal processing performed by the signal processing circuit 10C, the measurement hardware 10D analyzes the focus and the optical axis position of the reflected beam b2 entering the photoreceptor device 7 (step s6).

The main controller 10E evaluates the high-frequency characteristics and the like of the disc signal on the basis of the result of the analysis made by the measurement hardware 10D, and accordingly determines whether or not there is the need of optical axis adjustment, namely, the need of focus adjustment to the multi lens 6 and light-receiving point adjustment to the photoreceptor device 7 (step s7).

If the main controller 10E determines the need of focus adjustment to the multi lens 6 or light-receiving point adjustment to the photoreceptor device 7 in step s7, then the main controller 10E generates data required for carrying out the adjustments (step s8).

Next, when the optical pickup P is adjusted manually, based on the adjustment data shown on the display of the main controller 10E, the operator slides the multi lens 6 of the optical pickup P in the z-axis direction as illustrated in FIG. 1, and/or moves the photoreceptor device 7 in the x-axis and y-axis directions as illustrated in FIG. 1, and then fine-tunes the position of the multi lens 6 or the photoreceptor device 7. Alternatively, when the optical pickup P is adjusted by use of an automatic adjusting device (not shown), the computer PC sends the adjustment data to the automatic adjusting apparatus so that the multi lens 6 or the photoreceptor device 7 is fine-tuned in position as in the case of manual adjustment (step s9).

After the completion of focus adjustment to the multi lens 6 or light-receiving point adjustment to the photoreceptor device 7, the procedure of the steps s2 to s9 is repeated until the main controller 10E determines at step s7 that there is no need of focus adjustment to the multi lens 6 or light-receiving point adjustment to the photoreceptor device 7.

Then, when the main controller 10E determines at step s7 that there is no need of focus adjustment to the multi lens 6 or light-receiving point adjustment to the photoreceptor device 7, the adjustment process relating to the DVD laser diode LD1 of the optical pickup P is terminated.

When the optical pickup P is further equipped with a CD laser diode LD2 besides the DVD laser diode LD1 as described in FIG. 1, an optical axis adjuster designed for a CD optical system analyzes a disc signal outputted from the photoreceptor device 7 in the same procedure as in the foregoing case of the DVD laser diode LD1, and then, based on the analyzed result, the position of the CD laser diode LD2 is adjusted.

Such the foregoing conventional apparatus and method for adjusting optical pickup are showed in JP Pat. Publication No. 2002-133708.

As described hitherto, for adjustment to the optical pickup P, a conventional optical pickup adjusting apparatus actually applies an output beam b1 from the optical pickup P to the disc D, and then detects the beam b2 reflected from the disc D. The reason is as follows.

If the output beam b1 applied from the optical pickup is reflected off a mirror instead of the disc, even when the output beam 1 is not focused on the mirror (i.e. when it is impossible to actually read the information on the disc), the reflected beam b2 may be focused on the photoreceptor device 7, resulting in the impossibility to make a normal adjustment.

Because of this, an actual disc such as a DVD or a CD is used for making adjustment to the optical pickup P. In this event, however, the optical pickup adjusting apparatus is required to have a disc drive mechanism, a drive circuit configured only for executing various controls for tracking, auto-focusing and the like appropriate to the optical pickup P subject to adjustment, measurement hardware for analyzing a disc signal, and the like.

For this reason, in a conventional optical pickup adjusting apparatus, whenever the model of optical pickup P changes, it is necessary to make a change of drive circuit and control program. Therefore, it costs both large amount of labor and expenses at the time of beginning of new product introduction.

Further, a conventional optical pickup adjusting apparatus structured as described above needs to perform the processes for adjusting the focus of the multi lens 6, the position of the photoreceptor device 7, and the position of the CD laser diode LD2 independently of the process for making the attitude adjustment to the actuator operating the objective lens 5 by use of the beam spot adjuster (the initial-output optical axis adjustment). Such separation of processes causes the problems of complication in the facilities for the optical pickup adjustment, and occurrences of error in the adjusting processes.

### SUMMARY OF THE INVENTION

The present invention has been made to solve the problems associated with the conventional apparatus and method for adjusting an optical pickup as described hitherto.

Accordingly, an object of the present invention is to provide an apparatus and a method for adjusting an optical pickup that enable reductions in effort and costs incurred when the manufacturing of new products is launched, and also the prevention of complications in the facilities for adjusting the optical pickup and of occurrence of error in adjusting processes.

To achieve this object, in a first aspect, the present invention provides an apparatus for adjusting an optical pickup including: a light emission member; an objective lens provided for the directing of a beam outputted from the light emission member; an actuator for operating the objective lens; a multi lens for bringing the beam reflected into focus; and a photoreceptor device for receiving the beam reflected, and this apparatus has the feature of including: a light-receiving unit having a half mirror member allowing a portion of the beam outputted from the light emission member of the optical pickup subject to adjustment to pass therethrough, and reflecting a portion of the beam toward the optical pickup, and an optical system including a photoreceptor device receiving the beam passing through the half mirror member; a signal processing member that fetches a photoelectric conversion signal outputted from the photoreceptor device of the light-receiving unit as a result of receiving the beam, then generates from the photoelectric conversion signal a first focus error signal representing an optical axis position and a focal point of the beam entering the photoreceptor device of the light-receiving unit, and that also fetches a photoelectric conversion signal outputted from the photoreceptor device of the optical pickup as a result of receiving the beam reflected off the half mirror member, and then generates from the photoelectric conversion signal a second focus error signal representing an optical axis position and a focal point of the beam entering the photoreceptor device of the optical pickup; and a control member that operationally controls the actuator of the objective lens of the optical pickup on the basis of the first focus error signal supplied from the signal processing member, and generates adjustment data used for making focus adjustment and optical axis adjustment to the optical pickup on the basis of the second focus error signal.

Regarding the optical pickup adjusting apparatus in the first aspect of the present invention, an optical pickup subject to adjustment is located in a predetermined position, and then a beam is outputted from the light emission member of the optical pickup toward the light receiving unit, thereby performing the attitude control on the actuator operating the objective lens of the optical pickup, the focus adjustment to the multi lens, and the optical axis adjustment to the photoreceptor device.

Specifically, a portion of the beam outputted from the light emission member of the optical pickup toward the light receiving unit passes through the half mirror member of the light receiving unit, and enters the photoreceptor device of the light receiving unit, and then a photoelectric conversion signal is outputted from the photoreceptor device to the signal processing member.

The signal processing member fetches the photoelectric conversion signal outputted from the photoreceptor device of the light receiving unit, and then generates a first focus error signal representing the optical axis position and the focal point of the beam entering the photoreceptor device of the light receiving unit.

Then, based on the first focus error signal generated by the signal processing member, the control member performs the attitude control on the actuator operating the objective lens of the optical pickup, so that the beam outputted from the optical pickup is focused on the half mirror member and also the optical axis of the beam is aligned with that of the photoreceptor device of the light receiving unit.

On the other hand, the beam reflected from the half mirror member of the light receiving unit enters the photoreceptor device of the optical pickup. Then the photoreceptor device also outputs a photoelectric conversion signal. The signal processing member fetches the photoelectric conversion signal outputted from the photoreceptor device of the optical pickup, and thus generates, from the photoelectric conversion signal, a second focus error signal representing the optical axis position and the focal point of the beam entering the photoreceptor device of the optical pickup.

Then the control member, after the completion of attitude control on the actuator of the objective lens of the optical pickup based on the first focus error signal, generates adjustment data used for making the focus adjustment and the optical axis adjustment to the optical pickup on the basis of the second focus error signal.

Based on the adjustment data thus generated, the operator manually adjusts, or alternatively an adjusting device automatically adjusts the position of the multi lens of the optical pickup for the focus adjustment, and adjusts the position of the photoreceptor device of the optical pickup for the optical axis adjustment.

As described hitherto, with the optical pickup adjusting apparatus according to the present invention, without the use of a disc, a light receiving unit having a structure similar to that of an optical pickup subject to adjustment receives a beam outputted from the optical pickup in order to adjust the optical axis. This eliminates the need for a disc drive mechanism, a drive circuit configured only for executing various controls for tracking, auto-focusing and the like appropriate to the optical pickup subject to adjustment, measurement hardware for analyzing a disc signal, and the like, as are needed conventionally.

As a result, besides having this simplification in its structure, the apparatus for adjusting the optical pickup according to the present invention is capable of easily accommodating the changing of models of the optical pickup, and therefore of offering a significant reduction in effort and costs incurred when launching the manufacturing of new products.

Further, the apparatus for adjusting the optical pickup according to the present invention is capable by itself of continuously carrying out the attitude adjustment to the actuator, the focus adjustment to the multi lens and the attitude adjustment to the photoreceptor device of the optical pickup. This makes it possible to simplify the facilities for the optical-axis adjustment to the optical pickup and also prevent the occurrence of errors in the adjusting processes.

To achieve the aforementioned object, in a second aspect, the present invention provides a method for adjusting an optical pickup including: a light emission member; an objective lens provided for the directing of a beam outputted from the light emission member; an actuator for operating the objective lens; a multi lens for bringing the beam reflected into focus; and a photoreceptor device for receiving the beam reflected, and this method of adjusting the optical pickup has the feature of including the steps of: outputting the beam from the light emission member of the optical pickup subject to adjustment in a direction of a half mirror member allowing a portion of the beam to pass therethrough and reflecting a portion of the beam; receiving the beam passing through the half mirror member on a photoreceptor device of an optical system having the same structure as that of the optical pickup; generating a first focus error signal, representing an optical-axis position and a focal point of the beam entering the photoreceptor device of the optical system, on the basis of a photoelectric conversion signal outputted from the photoreceptor device of the optical system as a result of receiving the beam; controlling operation of the actuator of the objective lens of the optical pickup on the basis of the first focus error signal, so that the beam outputted from the light emission member of the optical pickup and passing through the half mirror member is focused on a receiving surface of the photoreceptor device of the optical system and also an optical axis of the beam is aligned with an optical axis of the receiving surface; receiving the beam, reflected from the half mirror member, on the photoreceptor device of the optical pickup subject to adjustment; generating a second focus error signal, representing an optical-axis position and a focal point of the beam entering the photoreceptor device of the optical pickup, on the basis of a photoelectric conversion signal outputted from the photoreceptor device of the optical pickup as a result of receiving the beam; and generating adjustment data on the basis of the second focus error signal for making positional adjustments to the multi lens and the photoreceptor device of the optical pickup so that the beam outputted from the light emission member of the optical pickup and reflected off the half mirror member is focused on a receiving surface of the photoreceptor device of the optical pickup and also an optical axis of the beam is aligned with an optical axis of the receiving surface.

As regards the method of adjusting the optical pickup according to the present invention, an optical pickup subject to adjustment is placed in a predetermined position, and then a beam is outputted from the light emission member of the optical pickup toward a half mirror member. The half mirror member allows a portion of the beam to pass therethrough and reflects a portion of the beam.

The portion of the beam outputted from the light emission member of the optical pickup, which passes through the half mirror member, enters the photoreceptor device of the optical system having the same structure as that of the optical pickup.

When the photoreceptor device of the optical system receives the beam, the beam is photoelectrically converted. Thus the photoreceptor device outputs a photoelectric conversion signal. Based on the photoelectric conversion signal, a first focus error signal representing the optical-axis position and the focal point of the beam entering the photoreceptor device is generated.

Further, based on the first focus error signal, attitude control is performed on the actuator operating the objective lens of the optical pickup, so that the beam outputted from the light emission member of the optical pickup and travelling through the half mirror member focuses on the receiving surface of the photoreceptor device of the optical system and the optical axis of the beam is aligned with the optical axis of the receiving surface.

On the other hand, the beam reflected off the half mirror member enters the photoreceptor device of the optical pickup subject to adjustment. The photoreceptor device of the optical pickup receives the beam and thereupon outputs a photoelectric conversion signal. Based on the photoelectric conversion signal, a second focus error signal representing the optical-axis position and the focal point of the beam entering the photoreceptor device concerned is generated.

Further, data for making adjustments is created on the basis of the second focus error signal. With this data, the positions of the multi lens and the photoreceptor device of the optical pickup are adjusted, so that the beam outputted from the light emission member of the optical pickup and then reflected by the half mirror member focuses on the receiving surface of the photoreceptor device of the optical pickup, and its optical axis comes into alignment with that of the receiving surface.

As described hitherto, the method of adjusting the optical pickup according to the present invention achieves an optical-axis adjustment without the use of a disc. This eliminates the need for a disc drive mechanism, a drive circuit configured only for executing various controls for tracking, auto-focusing and the like appropriate to the optical pickup subject to adjustment, measurement hardware for analyzing a disc signal, and the like, as are needed conventionally.

As a result, it is possible to make the optical-axis adjustment to the optical pickup by use of an apparatus of a simple structure, and thus to accommodate the changing of models of the optical pickup, thereby significantly reducing the effort and costs incurred when launching the manufacturing of new products.

Further, the method for adjusting the optical pickup according to the present invention achieves the combination of the attitude adjusting process for the actuator, the focus adjusting process for the multi lens and the attitude adjusting process for the photoreceptor device of the optical pickup. This makes it possible to simplifies the facilities for making the optical-axis adjustment to the optical pickup and also prevent the occurrence of errors in the adjusting processes.

These and other objects and features of the present invention will become more apparent from the following detailed description with reference to the accompanying drawings.

### BRIEF DESCRIPTION OF THE DRAWINGS

FIG. 1 is a perspective view schematically illustrating the structure of an optical pickup.

FIG. 2 is a block diagram of a conventional optical axis adjuster.

FIG. 3 is a more detailed block diagram illustrating the conventional optical axis adjuster.

FIG. 4 is a flow chart illustrating the steps of a conventional optical axis adjustment.

FIG. 5 is a block diagram illustrating an optical-pickup adjusting apparatus according to the present invention.

FIG. 6 is a more detailed block diagram illustrating the optical-pickup adjusting apparatus.

FIG. 7 is a side view illustrating the structure of a half mirror in the optical-pickup adjusting apparatus.

FIG. 8 is a flow chart illustrating the steps of an optical pickup adjustment performed by the optical-pickup adjusting apparatus.

FIGS. 9A, 9B and 9C are diagrams for illustrating the principle of focus adjusting in the optical-pickup adjusting apparatus.

FIG. 10 is a diagram for illustrating the principle of optical-axis adjusting in the optical-pickup adjusting apparatus.

### DETAILED DESCRIPTION OF THE PREFERRED EMBODIMENT

A preferred embodiment according to the present invention will be described below in detail with reference to the accompanying drawings.

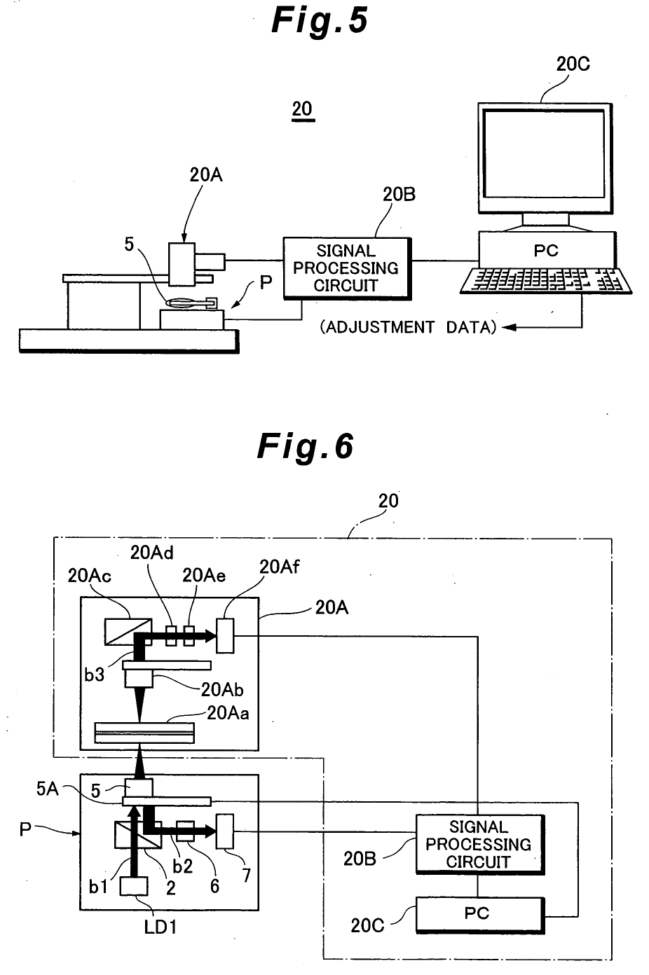

FIGS. 5 and 6 are block diagrams illustrating an embodiment of an apparatus for adjusting an optical pickup (referred to as “optical-pickup adjusting apparatus”) according to the present invention.

In FIGS. 5 and 6, an optical-pickup adjusting apparatus 20 includes: a light receiving unit 20A for receiving an output beam b1 from the optical pickup P; a signal processing circuit 20B for processing a photoelectric conversion signal outputted from the light receiving unit 20A and a photoelectric conversion signal outputted from the photoreceptor device 7 of the optical pickup P; and a main controller (personal computer) 20C performing an attitude control on the actuator 5A of the optical pickup P on the basis of a focus error signal processed by the signal processing circuit 20B, and determining the need for adjustments to the optical pickup, and further creating data for performing the adjustments.

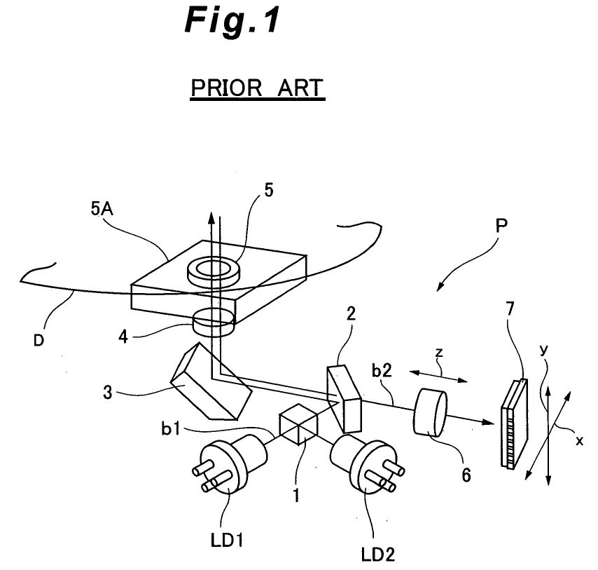

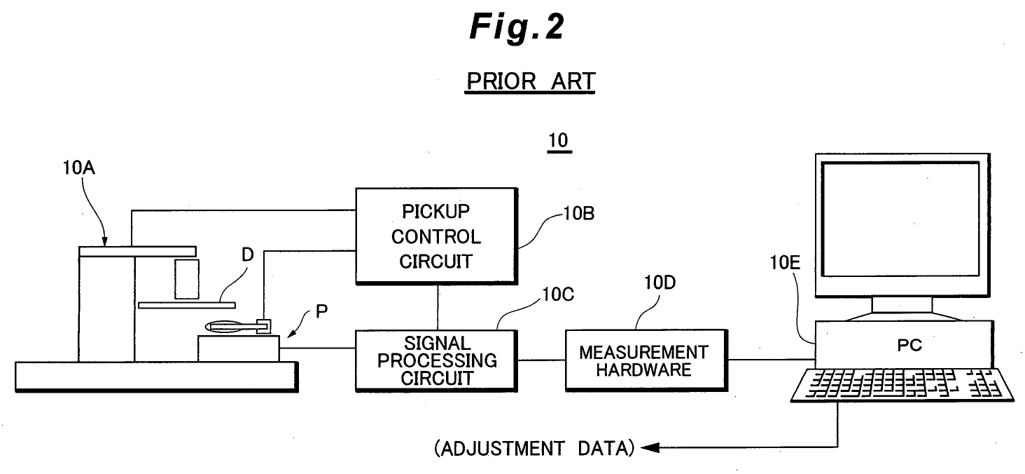

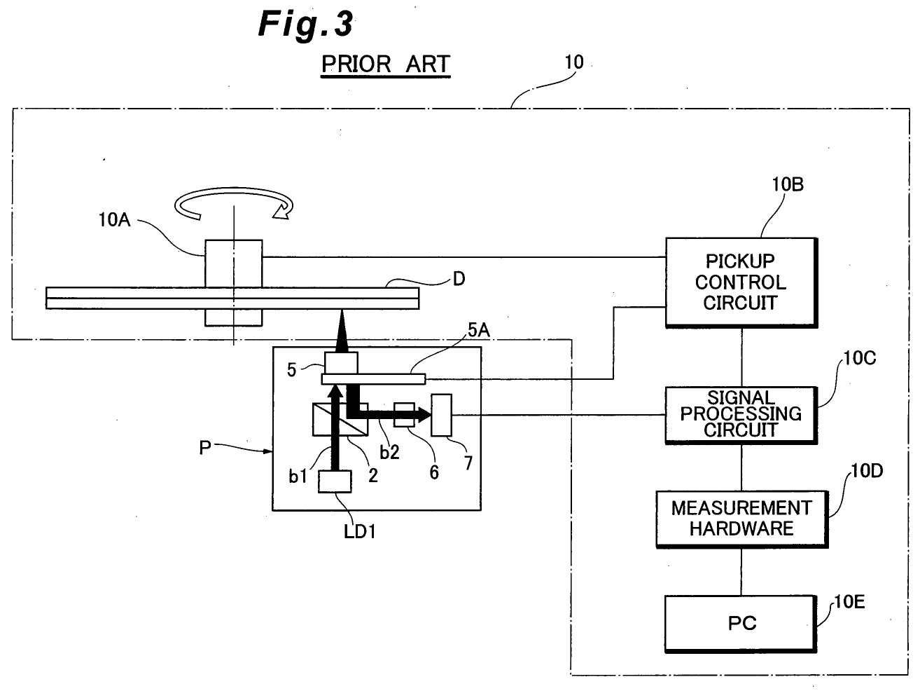

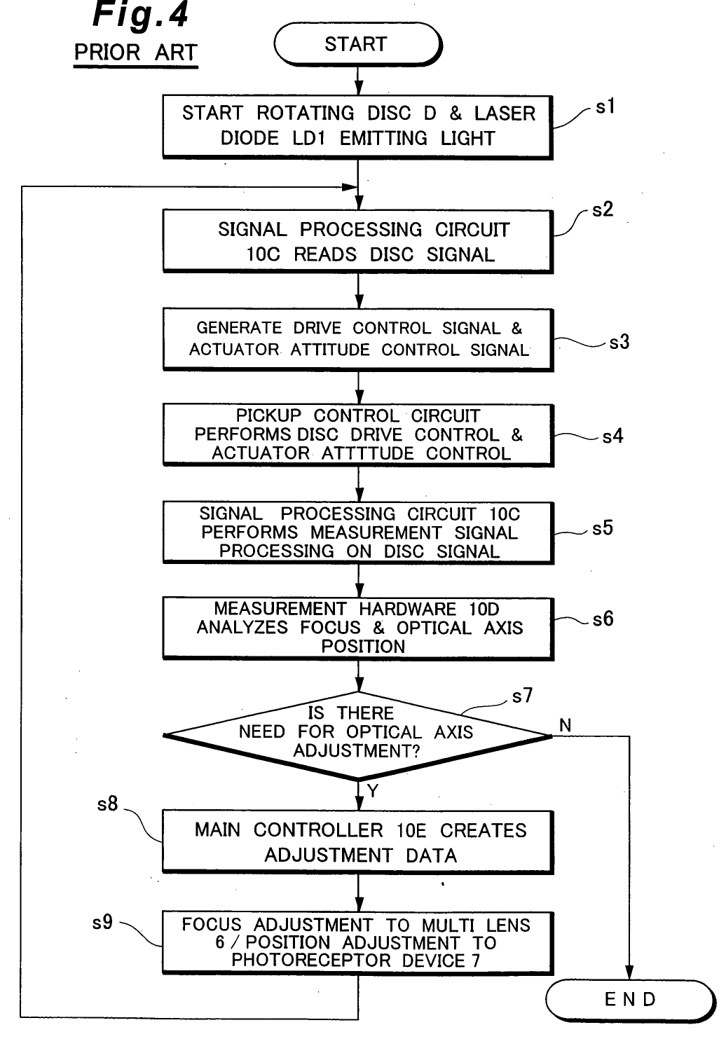

The light receiving unit 20A in turn includes a half mirror 20Aa placed in a position receiving the output beam b1 from the objective lens 5 of the optical pickup P (see FIG. 1), and an objective lens 20Ab, a mirror 20Ac, a collimator lens 20Ad, a multi lens 20Ae and a photoreceptor device 20Af which form an optical system similar to the optical system of the optical pickup P.

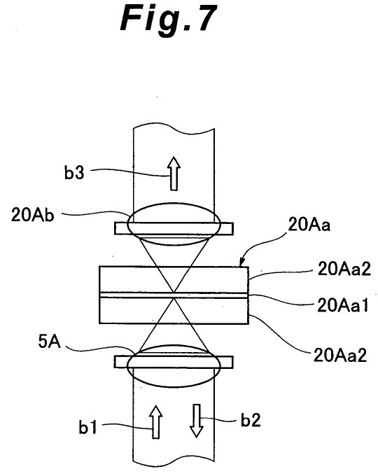

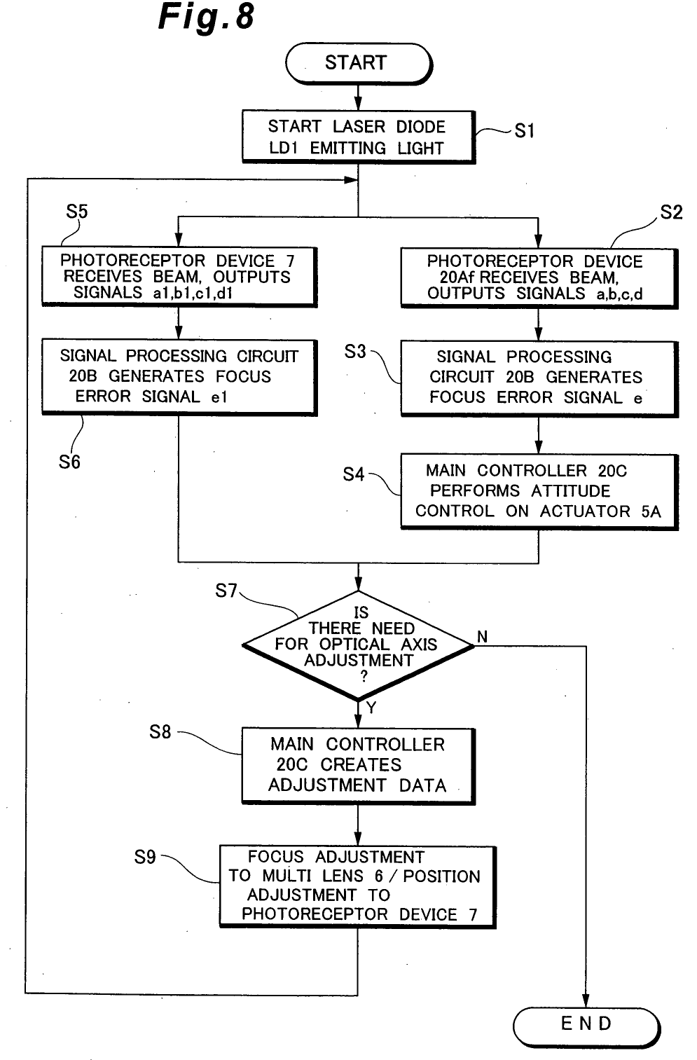

As enlargedly illustrated in FIG. 7, the half mirror 20Aa of the light receiving unit 20A is structured by sandwiching a half mirror body 20Aa1 between cover glasses 20Aa2 of the same material and the same thickness.

The multi lens 20Ae and the photoreceptor device 20Af of the light receiving unit 20A are each adjusted such that a through beam b3 passing through the half mirror 20Aa focuses on the photoreceptor device 20Af when the output beam b1 travelling from the optical pickup P toward the light receiving unit 20A focuses on the half mirror 20Aa.

Next, a description will be given of the procedure of the optical axis adjustment made to the optical pickup P by the optical pickup adjusting apparatus 20.

The optical pickup P subject to the optical axis adjustment is loaded in a checking position in the optical pickup adjusting apparatus 20, and is connected to a power supply circuit (not shown) Then, the photoreceptor device 7 is connected to the signal processing circuit 20B, and the actuator 5A is connected to the main controller 20C.

In this situation, the DVD laser diode LD1 of the optical pickup P is actuated to emit light. The output beam b1 emitted from the DVD laser diode LD1 enters the light receiving unit 20A (step S1).

Approximately half the quantity of the output beam b1 entering the light receiving unit 20A passes through the half mirror 20Aa and forms a through beam b3. The through beam b3 travels through the objective lens 20Ab, mirror 20Ac, collimator lens 20Ad and multi lens 20Ae to enter the photoreceptor device 20Af. At this point, the half mirror 20Aa is located in a position corresponding to the position of an actual disc. Hence, the through beam b3 passes through the half mirror 20Aa under the same conditions as in the case where the through beam b3 is reflected off the disc, which will be described later.

Upon reception of the through beam b3, the photoreceptor device 20Af of the light receiving unit 20A supplies photoelectric conversion signals a, b, c and d to the signal processing circuit 20B. The photoelectric conversion signals a, b, c and d represent the respective quantities of light received in divided screens of the photoreceptor device 20Af, which will be described later (step S2).

The signal processing circuit 20B processes the photoelectric conversion signals a, b, c and d supplied from the light receiving unit 20A to generate a focus error signal e on the basis of the following principle (step S3).

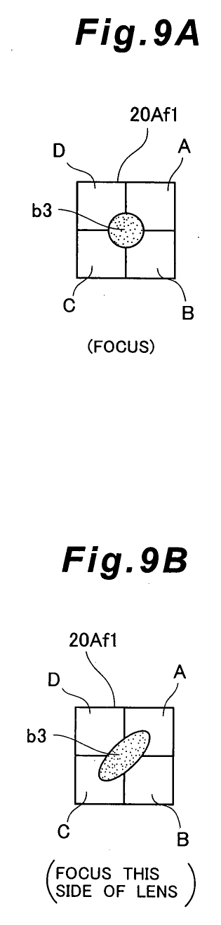

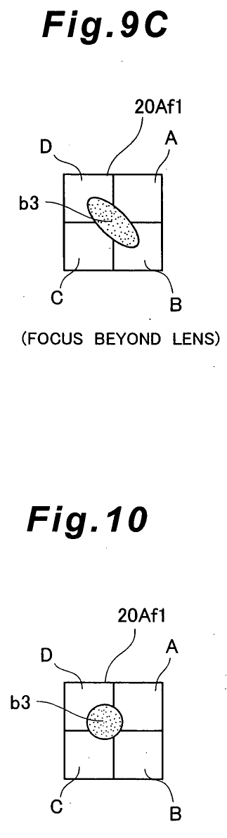

As illustrated in FIG. 9, the photoreceptor device 20Af has the receiving surface 20Af1 divided into quarter screens A, B, C and D. The photoelectric conversion signals a, b, c and d corresponding to the quantities of light received on the divided screens A, B, C and D are applied to the signal processing circuit 20B.

Then, the signal processing circuit 20B generates the focus error signal e from the photoelectric conversion signals a, b, c and d, supplied from the photoreceptor device 20Af of the light receiving unit 20A, on the basis of the following operational expression.

e=(a+c)−(b+d)

FIG. 9A illustrates when the through beam b3 passing through the half mirror 20Aa focuses on the photoreceptor device 20Af of the light receiving unit 20A (i.e. focused on the half mirror 20Aa). In this event, the outputs of the photoelectric conversion signals a, b, c and d are equal to each other. Therefore, based on the foregoing expression, the focus error signal e is outputted at zero from the signal processing circuit 20B.

FIG. 9B illustrates when the through beam b3 focuses at a point this side of the photoreceptor device 20Af of the light receiving unit 20A (i.e. focused at a point this side of the half mirror 20Aa). In this event, the outputs of the photoelectric conversion signals a, b, c and d are different from each other. Therefore, based on the foregoing expression, a positive focus error signal e is outputted from the signal processing circuit 20B.

FIG. 9C illustrates when the through beam b3 focuses at a point beyond the photoreceptor device 20Af of the light receiving unit 20A (i.e. focused at a point beyond the half mirror 20Aa) . In this event, the outputs of the photoelectric conversion signals a, b, c and d are different from each other. Therefore, based on the foregoing expression, a negative focus error signal e is outputted from the signal processing circuit 20B.

FIG. 10 illustrates when the optical axis of the through beam b3 is out of alignment with the center of the photoreceptor device 20Af of the light receiving unit 20A. In this event, different focus error signals e in accordance with the amount and the direction of deviation of the optical axis of the through beam b3 are supplied from the signal processing circuit 20B to the main controller 20C.

The main controller 20C performs attitude control on the actuator 5A of the optical pickup P on the basis of the focus error signal e supplied from the signal processing circuit 20B. Hence, an adjustment is made to enable the beam b3 to focus on the photoreceptor device 20Af of the light receiving unit 20A (i.e. on the half mirror 20Aa), and the optical axis of the beam b3 to be aligned with the center of the photoreceptor device 20Af (step S4).

On the other hand, another portion of the output beam b1 of the optical pickup P is reflected off the half mirror 20Aa toward the optical pickup P to form a reflected beam b2. The reflected beam b2 travels through the multi lens 6 to enter the photoreceptor device 7. Thus, photoelectric conversion signals a1, b1, c1 and d1, representing the amounts of light respectively received on the four divided screens of the photoreceptor device 7 as in the case of the photoreceptor device 20Af, are outputted from the photoreceptor device 7 to the signal processing circuit 20B (step S5).

The reflected beam b2 reflected by the half mirror 20Aa is equivalent in characteristics to the through beam b3 which passes through the cover glasses 20Aa2 of the same material and thickness provided on the both faces of the half mirror 20Aa in order to travel through the half mirror 20Aa toward the photoreceptor device 20Af.

In the same manner of processing as with the photoelectric conversion signals a, b, c and d supplied from the light receiving unit 20A, the signal processing circuit 20B performs the signal processing based on the photoelectric conversion signals a1, b1, c1 and d1 supplied from the photoreceptor device 7 to generate a focus error signal e1 (step S6).

Then, after completion of the attitude adjustment of the actuator 5A of the optical pickup P, the main controller 20C determines, based on the focus error signal e1 supplied from the signal processing circuit 20B, whether or not there is need for an optical axis adjustment, namely, need for a focus adjustment to the multi lens 6 and a light-receiving point adjustment to the photoreceptor device 7 (step S7).

If the output of the focus error signal e1 is not zero at step S7, the main controller 20C generates adjustment data for adjusting the focus of the multi lens 6 and the light-receiving point of the photoreceptor device 7 in accordance with the magnitude of the output of the focus error signal e1 (step S8).

When the adjustment is made to the optical pickup P by hand, based on the adjustment data shown on the display of the main controller 20C, the operator slides the multi lens 6 of the optical pickup P in the z direction and/or moves the photoreceptor device 7 in the x-axis and y-axis directions for fine-tuning (see FIG. 1). Alternatively, when the optical pickup P is adjusted by use of an automatic adjusting device (not shown), the main computer 20C sends the adjustment data to the automatic adjusting apparatus so that the position of the multi lens 6 or the photoreceptor device 7 is fine-tuned as in the case of manual adjustment (step S9).

After the completion of focus adjustment to the multi lens 6 or light-receiving point adjustment to the photoreceptor device 7, the procedure of the steps S5 to S9 is repeated until the main controller 20C determines at step S7 that there is no need for focus adjustment to the multi lens 6 or light-receiving point adjustment to the photoreceptor device 7.

Then, if the main controller 20C determines at step S7 that there is no need for focus adjustment to the multi lens 6 or light-receiving point adjustment to the photoreceptor device 7, the adjustment process relating to the DVD laser diode LD1 of the optical pickup P is terminated.

When the optical pickup P is further equipped with a CD laser diode LD2 besides the DVD laser diode LD1 as described in FIG. 1, the DVD laser diode LD1 is caused to emit light, and then by use a similar procedure as described above, positional adjustment for the CD laser diode DL2 is performed (see FIG. 1).

As described hitherto, with the optical pickup adjusting apparatus 20, without the use of a disc, the light receiving unit 20A, preset and having a structure similar to that of an optical pickup subject to adjustment, receives a output beam b1 travelling from the optical pickup P in order to adjust the optical axis. This eliminates the need for a disc drive mechanism, a drive circuit configured only for executing various controls for tracking, auto-focusing and the like appropriate to the optical pickup subject to adjustment, measurement hardware for analyzing a disc signal, and the like, as are needed conventionally.

As a result, besides having this simplification in its structure, the optical-pickup adjusting apparatus of the present invention is capable of easily accommodating the changing of models of the optical pickup, and therefore of achieving a significant reduction in the effort and costs incurred when launching the manufacturing of new products.

Further, the optical-pickup adjusting apparatus 20 is capable by itself of continuously carrying out the beam spot adjustment making attitude adjustment (an initial-output optical axis adjustment) to the actuator 5A of the optical pickup P, the focus adjustment to the multi lens 6, the position adjustment to the photoreceptor device 7, and the positional adjustment for the CD laser diode LD2. This makes it possible to simplify the facilities for making optical-axis adjustment to the optical pickup, and also to prevent the occurrence of errors in the adjusting processes.

A generic concept of the optical-pickup adjusting apparatus described in the foregoing embodiment is embodied in an apparatus for adjusting an optical pickup including: a light emission member; an objective lens provided for the directing of a beam outputted from the light emission member; an actuator for operating the objective lens; a multi lens for bringing the beam reflected into focus; and a photoreceptor device for receiving the beam reflected, and this apparatus includes: a light-receiving unit having a half mirror member allowing a portion of the beam outputted from the light emission member of the optical pickup subject to adjustment to pass therethrough, and reflecting a portion of the beam toward the optical pickup, and an optical system including a photoreceptor device receiving the beam passing through the half mirror member; a signal processing member that fetches a photoelectric conversion signal outputted from the photoreceptor device of the light-receiving unit as a result of receiving the beam, then generates from the photoelectric conversion signal a first focus error signal representing an optical axis position and a focal point of the beam entering the photoreceptor device of the light-receiving unit, and that also fetches a photoelectric conversion signal outputted from the photoreceptor device of the optical pickup as a result of receiving the beam reflected off the half mirror member, and then generates from the photoelectric conversion signal a second focus error signal representing an optical axis position and a focal point of the beam entering the photoreceptor device of the optical pickup; and a control member that operationally controls the actuator of the objective lens of the optical pickup on the basis of the first focus error signal supplied from the signal processing member, and generates adjustment data used for making focus adjustment and optical axis adjustment to the optical pickup on the basis of the second focus error signal.

In the optical pickup adjusting apparatus according to the generic concept, an optical pickup subject to adjustment is loaded in a predetermined position, and then a beam is outputted from the light emission member of the optical pickup toward the light receiving unit, thereby performing attitude control on the actuator of the objective lens of the optical pickup, focus adjustment to the multi lens, and optical axis adjustment to the photoreceptor device.

A portion of the beam outputted from the light emission member of the optical pickup in the direction of the light receiving unit passes through the half mirror member of the light receiving unit, and enters the photoreceptor device of the light receiving unit, and then a photoelectric conversion signal is outputted from the photoreceptor device to the signal processing member.

The signal processing member fetches the photoelectric conversion signal outputted from the photoreceptor device of the light receiving unit, and then generates a first focus error signal representing the optical axis position and the focal point of the beam entering the photoreceptor device of the light receiving unit.

Then, based on the first focus error signal generated by the signal processing member, the control member performs attitude control on the actuator of the objective lens of the optical pickup, so that the beam outputted from the optical pickup is focused on the half mirror member and also its optical axis is aligned with the axis of the photoreceptor device of the light receiving unit.

On the other hand, the beam reflected from the half mirror member of the light receiving unit enters the photoreceptor device of the optical pickup. Then the photoreceptor device also outputs a photoelectric conversion signal. The signal processing member fetches the photoelectric conversion signal outputted from the photoreceptor device of the optical pickup, and thus generates, on the basis of the photoelectric conversion signal, a second focus error signal representing the optical axis position and the focal point of the beam entering the photoreceptor device of the optical pickup.

Then, the control member, after completing the attitude control on the actuator of the objective lens of the optical pickup based on the first focus error signal, generates adjustment data used for making focus adjustment and optical axis adjustment to the optical pickup on the basis of the second focus error signal.

Based on the adjustment data thus generated, the operator manually adjusts, or alternatively an adjusting device automatically adjusts, the position of the multi lens of the optical pickup for the focus adjustment, and adjusts the position of the photoreceptor device of the optical pickup for the optical axis adjustment.

With the optical pickup adjusting apparatus as described hitherto, without the use of a disc, a light receiving unit having a structure similar to that of an optical pickup subject to adjustment receives a beam outputted from the optical pickup in order to adjust the optical axis. This eliminates the need for a disc drive mechanism, a drive circuit configured only for executing various controls for tracking, auto-focusing and the like appropriate to the optical pickup subject to adjustment, measurement hardware for analyzing a disc signal, and the like, as are needed conventionally.

As a result, besides having this simplification in its structure, the apparatus for adjusting the optical pickup is capable of easily accommodating the changing of models of the optical pickup, and therefore of offering a significant reduction in the effort and costs incurred when launching the manufacturing of new products.

Further, the apparatus for adjusting the optical pickup according to the present invention is capable by itself of continuously carrying out the attitude adjustment to the actuator, the focus adjustment to the multi lens and the attitude adjustment to the photoreceptor device of the optical pickup. This makes it possible to simplify the facilities for making the optical-axis adjustment to the optical pickup and also prevent the occurrence of errors in the adjusting processes.

A generic concept of the optical-pickup adjusting method of the aforementioned embodiment is embodied in a method for adjusting an optical pickup including a light emission member; an objective lens provided for the directing of a beam outputted from the light emission member; an actuator for operating the objective lens; a multi lens for bringing the beam reflected into focus; and a photoreceptor device for receiving the beam reflected. This method of adjusting the optical pickup has the feature of including the steps of: outputting the beam from the light emission member of the optical pickup subject to adjustment in a direction of a half mirror member allowing a portion of the beam to pass therethrough and reflecting a portion of the beam; receiving the beam passing through the half mirror member on a photoreceptor device of an optical system having the same structure as that of the optical pickup; generating a first focus error signal, representing an optical-axis position and a focal point of the beam entering the photoreceptor device of the optical system, on the basis of a photoelectric conversion signal outputted from the photoreceptor device concerned as a result of receiving the beam; controlling operation of the actuator of the objective lens of the optical pickup on the basis of the first focus error signal, so that the beam outputted from the light emission member of the optical pickup and passing through the half mirror member is focused on a receiving surface of the photoreceptor device of the optical system and an optical axis of the beam is aligned with the optical axis of the receiving surface; receiving the beam, reflected from the half mirror member, on the photoreceptor device of the optical pickup subject to adjustment; generating a second focus error signal representing an optical-axis position and a focal point of the beam entering the photoreceptor device of the optical pickup on the basis of a photoelectric conversion signal outputted from the photoreceptor device of the optical pickup as a result of receiving the beam; and generating adjustment data on the basis of the second focus error signal for making positional adjustment to the multi lens and the photoreceptor device of the optical pickup, so that the beam outputted from the light emission member of the optical pickup and reflected from the half mirror member is focused on a receiving surface of the photoreceptor device of the optical pickup and also an optical axis of the beam is aligned with an optical axis of the receiving surface.

In the method of adjusting the optical pickup according to the generic concept, an optical pickup subject to adjustment is placed in a predetermined position, and then a beam is outputted from the light emission member of the optical pickup in the direction of a half mirror member. The half mirror member allows a portion of the beam to pass therethrough and reflects a portion of the beam.

The portion of the beam outputted from the light emission member of the optical pickup, which passes through the half mirror member, enters the photoreceptor device of the optical system having the same structure as that of the optical pickup.

When the photoreceptor device of the optical system receives the beam, the beam is photoelectrically converted. Thus the photoreceptor device outputs a photoelectric conversion signal. Based on the photoelectric conversion signal, a first focus error signal representing the optical-axis position and the focal point of the beam entering the photoreceptor device is generated.

Further, based on the first focus error signal, attitude control is performed on the actuator of the objective lens of the optical pickup, so that the beam outputted from the light emission member of the optical pickup and travelling through the half mirror member focuses on the receiving surface of the photoreceptor device of the optical system and the optical axis of the beam is aligned with the optical axis of the receiving surface.

On the other hand, the beam reflected from the half mirror member enters the photoreceptor device of the optical pickup subject to adjustment. The photoreceptor device of the optical pickup receives the beam and thereupon outputs a photoelectric conversion signal. Based on the photoelectric conversion signal, a second focus error signal representing the optical-axis position and the focal point of the beam entering the photoreceptor device concerned is generated.

Further, data for adjustments is created on the basis of the second focus error signal. With this data, the positions of the multi lens and the photoreceptor device of the optical pickup are adjusted, so that the beam outputted from the light emission member of the optical pickup and then reflected by the half mirror member is focused on the receiving surface of the photoreceptor device of the optical pickup, and also its optical axis is aligned with the optical axis of the receiving surface.

The method of adjusting the optical pickup as described hitherto achieves an optical-axis adjustment without the use of a disc. This eliminates the need for a disc drive mechanism, a drive circuit configured only for executing various controls for tracking, auto-focusing and the like appropriate to the optical pickup subject to adjustment, measurement hardware for analyzing a disc signal, and the like, as are needed conventionally.

As a result, it is possible to make the optical-axis adjustment to the optical pickup by use of an apparatus of a simple structure, and thus to accommodate the changing of models of the optical pickup, thereby significantly reducing the effort and costs incurred when launching the manufacturing of new products.

Further, the method for adjusting the optical pickup according to the present invention achieves the combination of the attitude adjusting process for the actuator, the focus adjusting process for the multi lens and the attitude adjusting process for the photoreceptor device of the optical pickup. This makes it possible to simplify the facilities for making the optical-axis adjustment to the optical pickup and also prevent the occurrence of errors in the adjusting processes.

The terms and description used herein are set forth by way of illustration only and are not meant as limitations. Those skilled in the art will recognize that numerous variations are possible within the spirit and scope of the invention as defined in the following claims.

What is claimed is:

1. An apparatus for adjusting an optical pickup including a light emission member, an objective lens provided for the directing of a beam outputted from the light emission member, an actuator for operating the objective lens, a multi lens for bringing the beam reflected into focus, and a photoreceptor device for receiving the beam reflected, the apparatus comprising:
a light-receiving unit having a half mirror member allowing a portion of the beam outputted from the light emission member of the optical pickup subject to adjustment to pass therethrough and reflecting a portion of the beam toward the optical pickup, and an optical system including a photoreceptor device receiving the beam passing through the half mirror member;
a signal processing member that fetches a photoelectric conversion signal outputted from the photoreceptor device of the light-receiving unit as a result of receiving the beam, then generates from the photoelectric conversion signal a first focus error signal representing an optical axis position and a focal point of the beam entering the photoreceptor device of the light-receiving unit, and that also fetches a photoelectric conversion signal outputted from the photoreceptor device of the optical pickup as a result of receiving the beam reflected off the half mirror member, and then generates from the photoelectric conversion signal a second focus error signal representing an optical axis position and a focal point of the beam entering the photoreceptor device of the optical pickup; and
a control member that operationally controls the actuator of the objective lens of the optical pickup on the basis of the first focus error signal supplied from the signal processing member, and generates adjustment data used for making focus adjustment and optical axis adjustment to the optical pickup on the basis of the second focus error signal.

2. An apparatus for adjusting an optical pickup according to claim 1, wherein the half mirror member of said light-receiving unit is constructed of a half mirror body and cover glasses of the same material and the same thickness provided on both faces of the half mirror body to sandwich the half mirror body.

3. An apparatus for adjusting an optical pickup according to claim 1, wherein the photoreceptor device of said light receiving unit has a receiving surface divided into a plurality of areas, and outputs, from the respective divided areas, the photoelectric conversion signals of the beam received.

4. An apparatus for adjusting an optical pickup according to claim 3, wherein the receiving surface of the photoreceptor device of said light receiving unit is equally divided into four areas by straight lines intersecting at right angles at the center of the receiving surface.

5. An apparatus for adjusting an optical pickup according to claim 1, wherein the photoreceptor device of said light receiving unit has a receiving surface divided into a plurality of areas, and said signal processing member generates the first focus error signal on the basis of the photoelectric conversion signals, respectively outputted from the divided areas of the receiving surface, by means of calculating a difference in output between the photoelectric conversion signals.

6. An apparatus for adjusting an optical pickup according to claim 1, wherein the photoreceptor device of the optical pickup has a receiving surface divided into a plurality of areas, and said signal processing member generates the second focus error signal on the basis of the photoelectric conversion signals, respectively outputted from the divided areas of the receiving surface, by means of calculating a difference in output between the photoelectric conversion signals

7. An apparatus for adjusting an optical pickup according to claim 1, wherein the adjustment data is data for moving a position of the multi lens of the optical pickup and a position of the photoreceptor device of the optical pickup.

8. An apparatus for adjusting an optical pickup according to claim 1, wherein said control member has a display and the adjustment data is shown on the display.

9. An apparatus for adjusting an optical pickup according to claim 1, further comprising an adjusting member for adjusting positions of the multi lens and the photoreceptor device of the optical pickup, wherein said control member outputs the adjustment data to the adjusting member to allow the adjusting member to make adjustments to the optical pickup.

10. A method for adjusting an optical pickup including a light emission member, an objective lens provided for the directing of a beam outputted from the light emission member, an actuator for operating the objective lens, a multi lens for bringing the beam reflected into focus, and a photoreceptor device for receiving the beam reflected, the method for adjusting the optical pickup comprising the steps of:
outputting the beam from the light emission member of the optical pickup subject to adjustment in a direction of a half mirror member allowing a portion of the beam to pass therethrough and reflecting a portion of the beam;
receiving the beam passing through the half mirror member on a photoreceptor device of an optical system having the same structure as that of the optical pickup;
generating a first focus error signal, representing an optical-axis position and a focal point of the beam entering the photoreceptor device of the optical system, on the basis of a photoelectric conversion signal-outputted from the photoreceptor device concerned as a result of receiving the beam;
controlling operation of the actuator of the objective lens of the optical pickup on the basis of the first focus error signal, so that the beam outputted from the light emission member of the optical pickup and passing through the half mirror member is focused on a receiving surface of the photoreceptor device of the optical system and also an optical axis of the beam is aligned with an optical axis of the receiving surface;
receiving the beam, reflected from the half mirror member, on the photoreceptor device of the optical pickup subject to adjustment;
generating a second focus error signal, representing an optical-axis position and a focal point of the beam entering the photoreceptor device of the optical pickup, on the basis of a photoelectric conversion signal outputted from the photoreceptor device of the optical pickup as a result of receiving the beam; and
generating adjustments data on the basis of the second focus error signal for making positional adjustment to the multi lens and the photoreceptor device of the optical pickup, so that the beam outputted from the light emission member of the optical pickup and reflected from the half mirror member is focused on a receiving surface of the photoreceptor device of the optical pickup and also an optical axis of the beam is aligned with an optical axis of the receiving surface.

11. A method for adjusting an optical pickup according to claim 10, wherein the half mirror member is structured by sandwiching a half mirror body between cover glasses made of the same material as each other and having the same thickness as each other.

12. A method for adjusting an optical pickup according to claim 10, wherein the receiving surface of the photoreceptor device of the light receiving unit is divided into a plurality of areas, and the photoreceptor device outputs the photoelectric conversion signals of the receiving beam from the respective divided areas.

13. A method for adjusting an optical pickup according to claim 12, wherein the receiving surface of the photoreceptor device of the light receiving unit is equally divided into the four areas by straight lines intersecting at right angles at the center of the receiving surface.

14. A method for adjusting an optical pickup according to claim 10, wherein the receiving surface of the photoreceptor device of said light receiving unit is divided into a plurality of areas, and based on the photoelectric conversion signals respectively outputted from the divided areas of the receiving surface, a difference in output between the photoelectric conversion signals is calculated to generate the first focus error signal.

15. A method for adjusting an optical pickup according to claim 10, wherein the receiving surface of the photoreceptor device of the optical pickup is divided into a plurality of areas, and said based on the photoelectric conversion signals respectively outputted from the divided areas of the receiving surface, a difference in output between the photoelectric conversion signals is calculated to generate the second focus error signal.

16. A method for adjusting an optical pickup according to claim 10, wherein based on the second focus error signal, the adjustment data is created for moving the position of the multi lens of the optical pickup and the position of the photoreceptor device of the optical pickup.

17. A method for adjusting an optical pickup according to claim 10, wherein the adjustment data is shown on a display.

18. A method for adjusting an optical pickup according to claim 10, wherein the adjustment data is supplied to an adjusting member for adjusting the positions of the multi lens and the photoreceptor device of the optical pickup to allow the adjusting member to make adjustments to the optical pickup.
